(19) United States
(12) Patent Application Publication
(10) Pub. No.: US 2023/0141677 A1
(43) Pub. Date: May 11, 2023

(54) THERMOMETER FOR CRYOGENIC APPLICATIONS

(71) Applicant: Endress+Hauser Wetzer GmbH+Co. KG, Nesselwang (DE)

(72) Inventors: Mijndert van der Beek, Dordrecht (NL); Dietmar Saecker, Nesselwang (DE); Michael Fries, Marktoberdorf (DE)

(21) Appl. No.: 17/995,221

(22) PCT Filed: Mar. 23, 2021
(86) PCT No.: PCT/EP2021/057441

§ 371 Date: Sep. 30, 2022

(30) Foreign Application Priority Data
Apr. 3, 2020 (DE) 10 2020 109 424.8

(51) Int. Cl. G01K 13/00; G01K 1/08; G01K 1/14; G01K 13/02

(52) U.S. Cl. CPC G01K 13/006; G01K 1/08; G01K 1/14; G01K 13/02

(57) ABSTRACT

A securement insert for securing a thermometer in a nipple of a tube comprises a holding element for securing the thermometer to the securement insert, and a stop that is embodied to prevent rotary movement relative to the tube. An arrangement having a thermometer and a securement insert is also disclosed. At least one component of the securement insert is embodied and/or arranged in such a manner that the securement insert is movable in the direction of a longitudinal axis of the nipple.

The invention relates to a securement insert for securing a thermometer in a nipple of a tube as well as to an arrangement for determining and/or monitoring temperature of a medium in a containment.

Thermometers are known in a wide variety of embodiments in the state of the art and their underlying measuring principles have likewise been described at length in the literature. Thus, there are thermometers, which use the expansion of a liquid, gas or solid of known coefficient of expansion for measuring temperature, or such, which correlate the electrical conductivity of a material with the temperature, such as, for example, in the case of application of resistance elements or thermocouples. In contrast, in the case of radiation thermometers, especially pyrometers, heat radiation of a substance is utilized for determining its temperature.

In the case of a temperature sensor in the form of a so-called thin film sensor, especially a Resistance Temperature Detector (RTD), for example, a sensor element is used, which is equipped with connection wires and applied on a substrate, wherein the rear face of the support substrate is, as a rule, coated with metal. Used as sensor elements, in such case, are so-called resistance elements, for example, in the form of platinum elements, which are obtainable commercially, for instance, bearing the designations, PT10, PT100, and PT1000.

In the case of temperature sensors in the form of thermocouples, in turn, the temperature is determined by a thermovoltage, which occurs between unilaterally connected thermocouple wires of different materials. For temperature measurement, usually thermocouples of DIN standard IEC584 are applied as temperature sensor, e.g. thermocouples of type K, J, N, S, R, B, T or E. However, also other material pairs, especially such having a measurable Seebeck effect, are possible.

The temperature sensors are frequently part of a measuring insert, which is introducible, for example, into an immersion body, or protective tube, extending into the medium. The protective tube thus fulfills, in principle, the function of a housing, which protects the measuring insert from the environment, e.g. aggressive media, excessive forces and/or high pressures and/or temperatures, of a process. The protective tube is, in turn, typically introduced into a nipple of a containment or tube.

Thermometers in pipelines are exposed to the flow of a medium, whereby various problems can result. In such case, among others, the particular installation plays a role. The thermometers are, for example, frequently installed in straight sections of the pipeline in such a manner that a longitudinal axis of the thermometer extends essentially perpendicularly to the flow direction of the medium. Alternatively, it is also possible to arrange a thermometer in a bend of a pipeline. The flow of the medium is responsible, in either case, for different mechanical forces, which act on the thermometer, e.g. forces such as shear forces, or forces, which are induced by vortex shedding. Vortex shedding can cause an oscillation of the thermometer.

Vortex formation in fluid flow can be in the form of a “Kármán vortex steet”. Such concerns a repeating pattern of eddies swirling in different directions, caused by the discontinuous separation of the flow of a medium around a body and resulting in an oscillation of such body. The closer the frequency of the oscillations is to the eigenfrequency of the body, which the medium flows around, the larger the oscillations that are induced. The frequency of the oscillations is determined e.g. by process parameters, such as the physical properties of the medium, the flow velocity and the shape of the thermometer.

The shedding of these vortices can in the worst case damage the thermometer. At least, the life of the thermometer is reduced. Thus, the possibility of vortex formation must be duly taken into consideration in the development of a thermometer for use in a flowing medium. Today, standard methods exist, such as ASME PTC 19.3 TW-2010 or DIN43772, defining different design rules for thermometers. Using these methods, a design of a thermometer can be checked for sensitivity to vortex formation. The available methods are, however, limited to certain thermometer forms and/or process conditions.

Fundamentally, one strives to separate an eigenfrequency of the thermometer and an eigenfrequency of the vortex shedding from one another. In this way, the probability of occurrence of the dangerous condition of resonant, vortex induced oscillations of the thermometer can be minimized. For example, in order to achieve such a separation of the frequencies, the geometry of the thermometer can be varied, e.g. by lessening the length of the thermometer, by increasing the diameter, and/or by using a comparatively large thickness of the protective tube.

Alternatively, when functional limitations do not permit certain changes of the dimensions of the thermometer, sometimes also mechanical supports or dampers are used, in order to lessen the sensitivity of the thermometer to vortex shedding. These mechanical supports or dampers are normally installed in a gap between the nipple, or the tube, and the exterior of the thermometer. The supports or dampers increase the eigenfrequency of the thermometer by lessening the free length of the thermometer. It proves to be difficult, however, so to mount the supports or dampers that a high degree of coupling, and therewith the desired effect, can be achieved. Another problem is that a fixed position of the support or the damper within the process cannot be assured due to different coefficients of thermal expansion of the different components of the thermometer. For this reason, at the moment, a corresponding embodiment of a thermometer having a support or damper does not, for example, meet the requirements of the standard, ASME PTC 19.3 TW-2010.

For cryogenic applications, thus, use at low temperatures, it is, as regards the thermal properties of the thermometer and its accuracy of measurement, and for reduction of heat conduction errors, advantageous to make the thermometer as long as possible with a diameter as small as possible. Also, it is advantageous to make the wall of the protective tube as thin as possible. Such a construction is, however, such as above described, especially disadvantageous with respect to vortex induced oscillations of the thermometer.

An object of the invention is to care for this set of problems and to provide a thermometer, which is also especially suitable for registering low temperatures of flowing media.

The object is achieved by the securement insert as defined in claim 1 as well as by the arrangement as defined in claim 14. Advantageous embodiments are set forth in the dependent claims.

With respect to the securement insert, the object of the invention is achieved by a securement insert for securing a thermometer in a nipple of a tube, comprising a holding element for securing the thermometer to the securement insert, and a stop, which is embodied to prevent rotary movement relative to the tube. According to the invention, at least one component of the securement insert is embodied and/or arranged in such a manner that the securement insert is movable in the direction of a longitudinal axis of the nipple.

Movability of the securement insert in parallel with the longitudinal axis can compensate temperature effects resulting from different coefficients of expansion. At the same time, the holding element is rigidly connected with the thermometer, such that a mechanical coupling effective for lessening probability of vortex induced oscillations is always present. An advantage of the invention is that a sufficient stability of the securement insert can be achieved with simultaneous compensation of arising temperature effects. The use of a securement insert of the invention thus permits optimizing the thermometer as regards its thermal properties. For example, the thermometer can be long and the protective tube can have a thin wall. The securement insert is, thus, preferably usable in the cryogenics field, i.e. at low temperatures.

In an embodiment, the securement insert further includes a basic body having a passageway for receiving the thermometer, wherein an exterior of the basic body is fitted to the geometric dimensions of an interior of the nipple. The basic body serves virtually as adapter between the nipple and at least one additional component of the securement insert.

Preferably, the basic body is embodied in such a manner that it is introducible in a defined position relative to an interior of the nipple. Advantageously, the basic body is connectable with the containment nipple by force, e.g. friction, securement and/or by material bonding. For example, the basic body can be secured to the interior of the nipple by means of a weld or the like.

It is, furthermore, advantageous that the basic body be embodied in the form of a hollow cylinder. In this way, the symmetry of the nipple, which is usually likewise cylindrical, can be matched.

In an embodiment, the securement insert includes a circularly shaped spring element, which is insertable, especially releasably, into the nipple or basic body. The spring element is especially sized in such a manner that it is insertable into the nipple or basic body with a predeterminable spring stress. The spring element can, thus, adapt to different expansions or contractions of various components of the securement insert, thermometer and/or nipple as a function of temperature conditions and correspondingly compensate various mechanical expansions or contractions of the different components as a result of different coefficients of thermal expansion.

In an additional embodiment of the securement insert, the stop comprises an elongated guide element, which is secured to a wall of the nipple or basic body, and the stop engages in a component of the securement insert, when the securement insert is introduced into the nipple. The stop is preferably connected with the wall of the nipple or basic body by force, e.g. friction, securement and/or material bonding, for example, the stop is welded to the wall.

At least one component of the securement insert, which is introduced into the nipple or into the basic body, then includes, for example, a cavity, a slot, or a seat, in which the stop engages, when the securement insert is inserted.

Thus, in an embodiment of the invention, it is advantageous that the spring element includes an elongated slot, wherein the guide element is secured in such a manner to a wall of the nipple or basic body that the guide element engages in the slot, when the spring element is arranged in the nipple or basic body. The guide element is preferably secured in such a manner in the nipple or basic body that a longitudinal axis of the guide element extends in parallel with a longitudinal axis of the nipple. A length of the guide element is especially adapted for the coefficients of thermal expansion and/or the expected mechanical expansions and/or contractions of the different components as a result of temperature changes.

An alternative embodiment includes that the stop comprises a screw threaded bolt. The screw threaded bolt includes at least a first part having a screw thread, which serves for securement to the basic body or the nipple, and a second, screw thread lacking part. Preferably, the screw threaded bolt is oriented in parallel with a longitudinal axis of the nipple. The screw threaded bolt can, however, additionally, also optionally comprise a third part, which likewise is provided with a screw thread. Preferably, then, the first and third parts are arranged in the two end regions of the screw threaded bolt.

At least the component of the securement insert, which is embodied and/or arranged in such a manner that the securement insert is movable in the direction of a longitudinal axis of the nipple, includes then a passageway, through which the screw threaded bolt is led, and which is arranged on the second part of the screw threaded bolt.

In an embodiment having a stop comprising a screw threaded bolt, the basic body has a circularly shaped floor, on which a tube with an internal screw thread for receiving the screw threaded bolt is mounted. The screw threaded bolt is, in such case, for example, screwed in with the first part into the internally threaded tube. By means of the screwed connection with the basic body in this embodiment, the stop is effective for blocking rotational movements of the thermometer.

In an embodiment of the securement insert, the holding element includes a circularly shaped element, in which the thermometer is securable.

For securing the thermometer in the circularly shaped element, all securements known per se to those skilled in the art can be used, for example, a screwed connection with mutually corresponding screw threads or using a set screw.

In an alternative embodiment of the securement insert, the holding element is embodied in the form of a cylindrical element having an, especially central, first passageway, in which the thermometer is securable, and wherein an outer diameter of the cylindrical element is fitted to an inner diameter of the nipple or basic body. The first passageway is especially a central passageway of a cross sectional area of the cylindrical element and its inner diameter is fitted to an outer diameter of the thermometer.

In the case of the embodiment of the holding element in the form of a cylindrical element, advantageously the holding element includes at least a second passageway for producing a fluid contact between an internal volume of the tube and an internal volume of the thermometer. The second passageway is an eccentric passageway of a cross sectional area of the cylindrical element.

Another embodiment includes that the holding element is connected by force securement, e.g. frictional securement, and/or by material bonding with the nipple, the basic body or the circularly shaped spring element. In this regard, either a releasable or non-releasable connection can be used.

For the case, in which the securement insert includes a circularly shaped spring element, an embodiment provides that the holding element includes a strut, which connects the holding element and the spring element. The holding element and the spring element are in this embodiment preferably rigidly connected together by material bonding. For example, the strut can be connected with the spring element and the holding element by means of two welded joints.

For the case, in which the securement insert has a basic body and the holding element has the form of a cylindrical element, an alternative embodiment includes that the basic body and the holding element are connectable with one another by means of a screwed connection, especially the holding element has at least a third passageway, wherein the holding element and the basic body are connectable with one another by means of the screw threaded bolt of the stop, by means of a screw, or by means of an additional screw threaded bolt.

The object of the invention is achieved, furthermore, by an arrangement for determining and/or monitoring temperature of a medium in a containment, comprising a measuring insert with a temperature sensor for determining and/or monitoring temperature of the medium, and a protective tube for receiving the measuring insert. According to the invention, the arrangement includes, furthermore, a securement insert of the invention according to at least one of the described embodiments.

In an embodiment, the arrangement includes a pressure take off nipple. Via the pressure take off nipple, it is, furthermore, possible to ascertain a pressure of the medium in the tube. Especially for the case of a cryogenic application, it is possible in this way to avoid the providing of an additional connection to the process through an, in given cases present, vacuum isolation of the tube, which would otherwise be required in the case of an additional measuring point.

It is to be noted here that the embodiments described in connection with the securement insert of the invention can be applied mutatis mutandis also for the arrangement of the invention and vice versa.

The invention and its advantageous embodiments will now be explained in greater detail based on the appended drawing, the figures of which show as follows:

FIG. 1 the source of vortex induced vibrations,

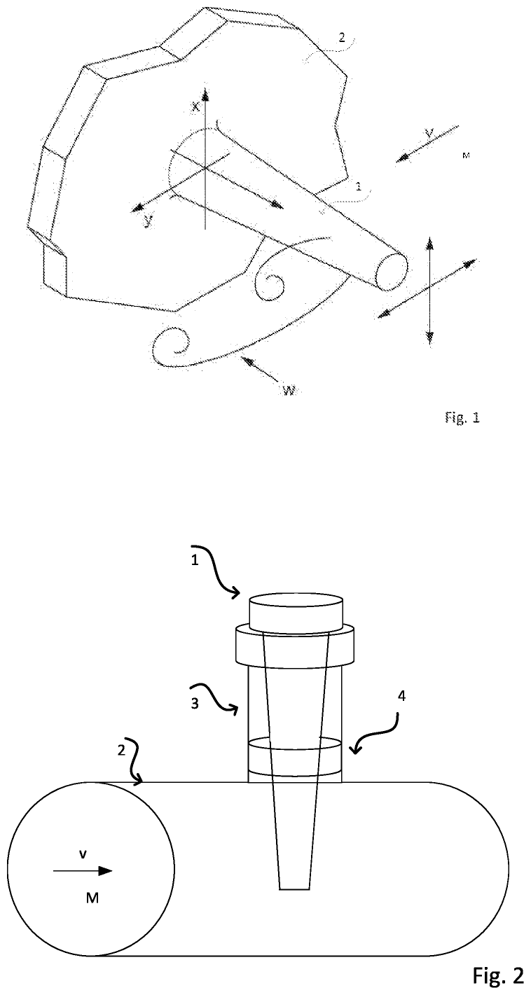

FIG. 2 a thermometer having a protective tube and a mechanical support,

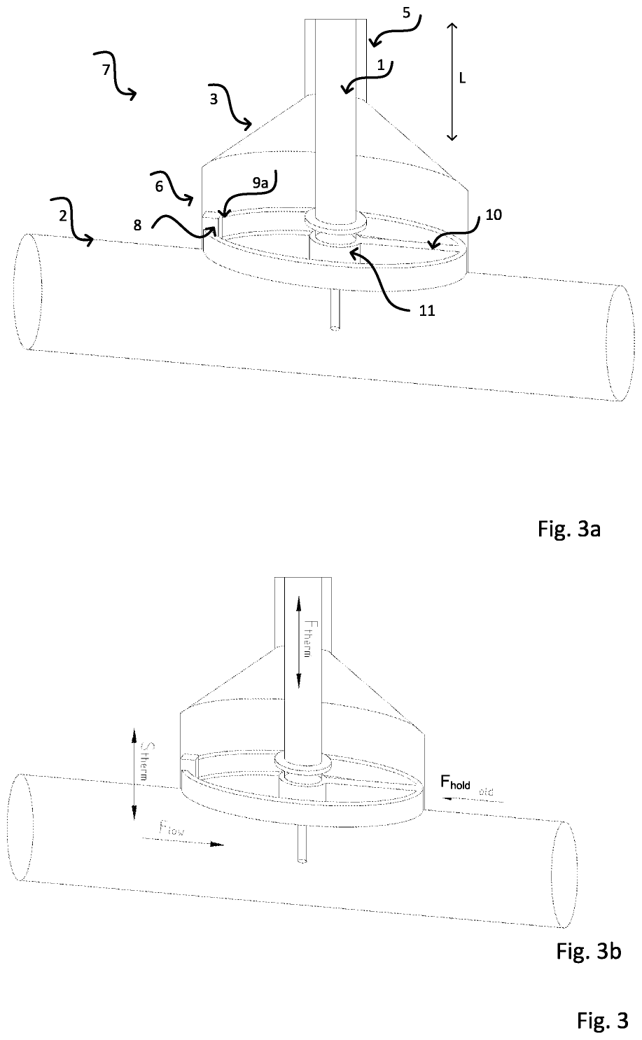

FIG. 3 a first embodiment of a thermometer having a securement insert of the invention, and

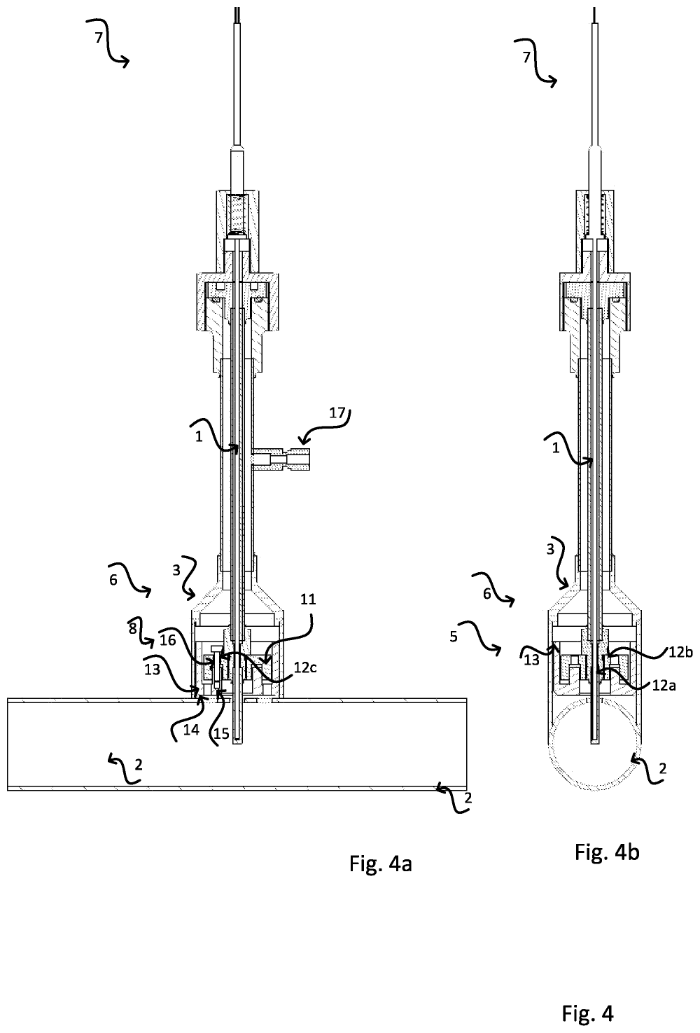

FIG. 4 a second embodiment of a thermometer having a securement insert of the invention.

In the figures, equal elements are provided with equal reference characters.

FIG. 1 shows how vortices are shed from a cylindrical, conically tapering thermometer 1 exposed to a medium M flowing in a tube 2. Tube 2 is shown here by its wall. There develops in flow direction v of the medium M behind the thermometer 1 a comb-shaped pattern of the flow profile. As a function of the flow velocity v of the medium M, such can lead to vortex shedding, which can, in turn, cause the thermometer 1 to oscillate.

The vibrations are brought about mainly by two forces acting on the thermometer 1: a shear force in the y direction and a lifting force in the x direction, which add to form the flow-determined, total force F_{flow}. The shear force causes oscillations with a frequency fs, while the lifting force causes oscillations with a frequency 2 fs. The frequency fs depends on the flow velocity v of the medium M and on various physical or chemical properties of the medium M such as its viscosity and density as well as on the geometry of the thermometer 1, such as its diameter, its length and the thickness of the wall of the protective tube. The closer the frequency fs is to the eigenfrequency of the thermometer 1 and the higher the flow velocity v of the medium M, the greater are the oscillation producing forces resulting therefrom. The thermometer 1 can be damaged by the action of these forces and the occurrence of vortex shedding. In the worst case, a complete failure of the thermometer 1 can occur. Such is referred to as a so-called resonance condition.

In order to reduce the sensitivity of thermometers to such vortex formation, such as above described, the design of the protective tube can be modified. However, the actions, which serve for optimizing the geometry of the thermometer 1 with respect to vortex shedding, and those, which serve for optimizing the thermometer 1 as regards temperature effects, especially temperature effects brought about by undesired heat drains, run basically in opposite directions.

Another way of preventing vortex induced oscillations of the thermometer 1 is using a mechanical support 4, such as shown in FIG. 2. The support 4 is introduced into a nipple 3 of the tube 2 and increases the eigenfrequency of the thermometer 1 by decreasing the free length of the thermometer 1.

Problematic in the case of such mechanical supports 4 is, however, that an effective mechanical coupling to the thermometer 1 cannot be assured at all times. Especially, mechanical expansions of the different components of the arrangement occurring upon temperature changes as a result of different coefficients of thermal expansion have made such solutions unreliable to this point in time.

The invention solves this problem using a securement insert 6, which is movable in parallel with a longitudinal axis L of the nipple 3. As a result of this movement in the direction of the longitudinal axis, temperature effects can be compensated, without influencing the mechanical coupling to the thermometer 1.

FIGS. 3 and 4 show two especially preferred embodiments of a securement insert 6 of the invention and an arrangement 7 of the invention. Tube 2 and nipple 3 are, in each case, embodied, by way of example, for application at low temperatures T and include, for example, in such case, a vacuum insulation (not separately shown).

In the case of the embodiment of FIG. 3, the securement insert 6 comprises a stop 8 in the form of an elongated guide element, which is welded to the interior of the nipple 3, as shown, for example, in FIG. 3a. Securement insert 6 further includes a circularly shaped spring element 9, whose geometric dimensions are likewise fitted to the dimensions of the nipple 3. The spring element 9 has a slot 9a, in which the stop 8 engages, when the spring element 9 is arranged in the nipple 3. The spring element 9 is, furthermore, connected via the strut 10 with the circularly shaped holding element 11, which serves for securing the thermometer 1. Stop 8 blocks rotary movement of the securement insert 6 in the nipple.

Movement Sₜₕₑᵣₘ in the direction of a longitudinal axis L of the nipple is, in contrast, possible and serves for compensating temperature effects in the form of thermally induced forces Fₜₕₑᵣₘ otherwise acting on the thermometer 1 and the securement insert 6. This is illustrated in FIG. 3b. The forces Fₜₕₑᵣₘ result from different coefficients of expansion of the different components and the associated different mechanical expansions as a result of temperature changes. The forces F_{hold} effected by the wall of the nipple 3 and the spring element serve for securing the holding element 11 against the thermometer 1, in order that thermometer 1 experiences, in turn, a reduced sensitivity to the forces F_{flow} caused by the flow, such as described above in connection with FIG. 1.

A second example of an especially preferred embodiment of a securement insert 6 of the invention and an arrangement 7 of the invention is shown in FIG. 4 with views rotated 90° relative to one another. As evident from FIG. 4a, the securement insert includes a basic body 13 in the form of a hollow cylinder, which is fixed in the nipple 3. For example, the basic body 13 is welded to the nipple 3. The basic body 13 has, furthermore, a circularly shaped floor 14, in which is mounted an internally screw threaded tube 15 for receiving the screw threaded bolt 16, which is part of the stop 8. By means of the screw threaded bolt 16, the basic body 13 is connected by force securement, e.g. frictional securement, with the holding element 11, which is embodied in such case in the form of a cylindrical element. The holding element 11 has, such as shown in FIG. 4b, a first passageway 12a for receiving the thermometer 1, a second passageway 12b for producing a fluid contact between an internal volume of the tube 2 and an internal volume of the thermometer 1, as well as a third passageway 12c for securing the holding element 11 with the basic body 13 by means of the screw threaded bolt 15.

Also for this second variant of a securement insert, a movement in the longitudinal direction of the nipple 3 is possible, while a rotary movement is prevented by the stop 8. Correspondingly, as in the case of the embodiment of FIG. 3, forces Fₜₕₑᵣₘ resulting from temperature effects and flow related forces F_{flow} can be compensated.

In the embodiment of FIG. 4, the arrangement 7 further includes a pressure take off nipple 17 for measuring a pressure of the medium M. Such is enabled by the fluid contact between an internal volume of the tube 2 and an internal volume of the thermometer 1, which for the shown case is assured by the second passageway 12b.

### REFERENCE CHARACTERS

1 thermometer

2 tube

3 nipple

4 mechanical support

5 vacuum insulation

6 securement insert

7 arrangement

8 stop

9 spring element

10 strut

11 holding element

12 passageways

13 basic body

14 floor of the basic body

15 tube

16 screw threaded bolt

17 pressure take off nipple

1-16. (canceled)

17. A securement insert for securing a thermometer in a nipple of a tube, comprising:
a holding element for securing the thermometer to the securement insert; and
a stop embodied to prevent rotary movement relative to the tube,
wherein at least one component of the securement insert is embodied and/or arranged such that the securement insert is movable in the direction of a longitudinal axis of the nipple.

18. The securement insert as claimed in claim 17, further comprising:
a basic body having a passageway for receiving the thermometer, wherein an exterior of the basic body is fitted to geometric dimensions of an interior of the nipple.

19. The securement insert as claimed in claim 18,
wherein the basic body is embodied in the form of a hollow cylinder.

20. The securement insert as claimed in claim 18, further comprising:
a circular spring element that is releasable insertable into the nipple or basic body.

21. The securement insert as claimed in claim 20,
wherein the stop includes an elongated guide element secured to a wall of the nipple or basic body, and the stop engages in a component of the securement insert when the securement insert is introduced into the nipple.

22. The securement insert as claimed in claim 21,
wherein the spring element includes an elongated slot, and
wherein the guide element is secured in such a manner to a wall of the nipple or basic body that the guide element engages in the slot when the spring element is arranged in the nipple or basic body.

23. The securement insert as claimed in claim 18,
wherein the stop comprises a screw threaded bolt.

24. The securement insert as claimed in claim 23,
wherein the basic body has a circularly shaped floor on which is mounted a tube with an internal screw thread for receiving the screw threaded bolt.

25. The securement insert as claimed in claim 18,
wherein the holding element includes a circularly shaped element in which the thermometer is securable.

26. The securement insert as claimed in claim 24,
wherein the holding element is embodied in the form of a cylindrical element having a central, first passageway in which the thermometer is securable, and wherein an outer diameter of the cylindrical element is fitted to an inner diameter of the nipple or basic body.

27. The securement insert as claimed in claim 26,
wherein the holding element includes a second passageway for producing a fluid contact between an internal volume of the tube and an internal volume of the thermometer.

28. The securement insert as claimed in claim 20,
wherein the holding element is connected by force securement and/or by material bonding with the nipple, the basic body, or the circularly shaped spring element.

29. The securement insert as claimed in claim 28,
wherein the holding element includes a strut that connects the holding element and the spring element.

30. The securement insert as claimed in claim 28,
wherein the basic body and the holding element are connectable with one another by means of a screwed connection,
wherein the holding element has a third passageway, and
wherein the holding element and the basic body are connectable with one another by means of the screw threaded bolt of the stop, by means of a screw, or by means of an additional screw threaded bolt.

31. An arrangement for determining and/or monitoring temperature of a medium in a containment, comprising:
a measuring insert with a temperature sensor for determining and/or monitoring temperature of the medium, and
a protective tube for receiving the measuring insert,
wherein the arrangement further includes a securement insert, including:
a holding element for securing the temperature sensor to the securement insert; and
a stop embodied to prevent rotary movement relative to the tube,
wherein at least one component of the securement insert is embodied and/or arranged such that the securement insert is movable in the direction of a longitudinal axis of the nipple.

32. The arrangement as claimed in claim 31, further comprising:
a pressure take off nipple.
